(19) United States
(12) Patent Application Publication
(10) Pub. No.: US 2017/0066424 A1
(43) Pub. Date: Mar. 9, 2017

(54) Brake Booster For A Motor Vehicle Brake System, Comprising A Retaining Mechanism For A Restoring Spring, And Brake Booster Assembly

(71) Applicant: LUCAS AUTOMOTIVE GMBH, Koblenz (DE)

(72) Inventors: Paul Warkentin, Neuwied (DE); Jose-Manuel Calvo Martinez, Kruft (DE); Kurt Wingender, Hartenfels (DE)

(73) Assignee: Lucas Automotive GmbH, Koblenz (DE)

(21) Appl. No.: 15/104,158

(22) PCT Filed: Nov. 6, 2014
(86) PCT No.: PCT/EP2014/073944

§ 371 Date: Oct. 19, 2016

(30) Foreign Application Priority Data
Dec. 13, 2013 (DE) 10 2013 021 122.0

(51) Int. Cl. B60T 13/567; B60T 13/57

(52) U.S. Cl. CPC B60T 13/567; B60T 13/57

(57) ABSTRACT

The invention relates to a brake booster (10) for a motor vehicle brake system, comprising a force input member (12) that is or can be coupled to a brake pedal and can be moved along a movement axis (V), a control valve (14) that can be actuated according to a movement of the force input member (12), a chamber arrangement (20) that is disposed in a booster housing (18), can be controlled by the control valve (14), and is provided with at least one negative-pressure chamber (28, 30) and at least one working chamber (24, 26) which are separated from each other by at least one movable wall (32, 34) coupled to the control valve (14), and a force output member (42) for applying a braking force to a downstream master brake cylinder arrangement. The control valve (14) is biased in a starting position along with the force output member (42) by means of a restoring spring (48), a first end of which rests on the control valve (14). According to the invention, the booster housing (18) includes a receiving opening (50) for the downstream master brake cylinder arrangement (58), said opening (50) being provided with at least one axial guiding section (56) and at least one radial stop section (54) which are designed to support a second end of the restoring spring (48).

The present invention relates to a brake booster for a motor-vehicle brake system, with a force-input member which is coupled or can be coupled with a brake pedal and is displaceable along a displacement axis, with a control valve which can be actuated in accordance with a displacement of the force-input member, with a chamber arrangement, which is arranged in a booster housing and can be selected via the control valve, with at least one vacuum chamber and at least one working chamber, which have been separated from one another via at least one movable wall coupled with the control valve, and with a force-output member for delivering a brake force to a downstream master-brake-cylinder arrangement, wherein the control valve with the force-output member has been biased into an initial position with the aid of a restoring spring, wherein the restoring spring is supported with a first end on the control valve.

A brake booster of such a type is known from the prior art and is shown, for example, in document DE 10 2008 035 179 A1. In this case it is furthermore stipulated that the restoring spring is supported with a second end on the master-brake-cylinder arrangement. The master-brake-cylinder arrangement projects into the booster housing through a receiving opening, said receiving opening having a generally larger diameter than the cylindrically designed restoring spring.

In the course of the assembly of the brake booster with the master-brake-cylinder arrangement the restoring spring firstly has to be inserted between the control valve and the receiving opening in the booster housing. Consequently there is a risk of the restoring spring slipping out of the receiving opening or becoming wedged within the booster housing before the master-brake-cylinder arrangement is brought together with the brake booster. As a result, the restoring spring and other components of the brake booster can be damaged, and the assembly sequence is disrupted. Comparable problems may similarly arise in the course of maintenance or repair work as soon as the brake booster and the master-brake-cylinder arrangement are separated again. For the purpose of avoiding these problems, the solution according to document DE 10 2008 035 179 A1 provides a retaining device for the restoring spring, in the form of a supporting ring. The latter is arranged between the restoring spring and the receiving opening and exceeds the diameter of the receiving opening, so that neither the supporting ring nor the restoring spring can fall out of the receiving opening.

With this solution, however, it has turned out to be a disadvantage that the supporting ring has to be integrated as an additional component into the sequence of assembly of the brake booster, entailing a corresponding expenditure of time and money.

It is therefore an object of the present invention to make available a brake booster of the type described at the outset, which, by inexpensive and simple means, prevents the restoring spring from accidentally falling out of the booster housing.

This object is achieved by a brake booster of the type described at the outset, in the case of which it is stipulated that the booster housing exhibits a receiving opening for the downstream master-brake-cylinder arrangement, said opening having been designed with at least one axial guide portion and with at least one radial stop portion, which have each been configured to support a second end of the restoring spring.

As distinct from the state of the art, the invention no longer provides that an additional component in the form of a supporting ring has to be installed in the brake booster. Rather, the inventors have recognised that the insertion of the additional supporting ring and the correct positioning thereof on the receiving opening comprises numerous complex handling steps and consequently distinctly increases the necessary expenditure of time and money. Instead of this, the invention provides that a comparably acting retaining device has been formed or fitted directly on the booster housing or on the receiving opening thereof. In this connection, an integral forming of the retaining device on the booster housing has proved to be a particularly advantageous variant according to the invention. As a result, all the additional handling steps—and the accompanying potentials for error—required in the prior art are dispensed with.

In accordance with the invention, the retaining device has been designed in the form of the at least one axial guide portion and the at least one radial stop portion, which have been arranged on the receiving opening. By virtue of these portions, the restoring spring can be effectively prevented both from falling out of the receiving opening—that is to say, slipping in the axial direction—and from tilting or slipping in the radial direction.

A further development of the invention provides that the guide portion and the stop portion extend at least partly in a common peripheral-segment region of the receiving opening and have been arranged to be axially adjacent. According to this further development, the guide portion and the stop portion, viewed in an axis-including section, can consequently define a stepped portion of the receiving opening, with which the second end of the restoring spring is supported. In this connection it may, for example, be stipulated that the guide portion and the stop portion have been arranged in such a manner that the guide portion surrounds the restoring spring from the inside or from the outside over a certain peripheral-segment region—that is to say, for example, that the guide portion extends into a typically cylindrical inner cavity spanned by the restoring spring or extends along an outer peripheral surface of the restoring spring.

In a further development of the invention it is stipulated that the guide portion and the stop portion extend substantially in different peripheral-segment regions of the receiving opening. In other words, in this further development it is stipulated that the guide portion and the stop portion have been arranged along the periphery of the receiving opening very largely offset in relation to one another. As a result, a retaining device of particularly compact design can be made available, since the guide portion and the stop portion may extend at least partly over a common axial region.

In this context it may furthermore be stipulated in accordance with the invention that the receiving opening has been designed with a plurality of guide portions and/or stop portions, and the guide portions and stop portions have been arranged to be substantially uniformly distributed along the periphery of the receiving opening. By provision of a plurality of guide portions and/or stop portions, a particularly reliable retaining action is guaranteed, in which connection a reliable positioning or a centred orientation of the restoring spring in the radial direction can be obtained, in particular, by provision of a plurality of guide portions. By virtue of the uniform distribution along the periphery of the receiving opening, the assembly process in the course of inserting the master-brake-cylinder arrangement into the receiving opening can be facilitated, as described in more detail below, since the orientation of these components relative to one another is facilitated.

A further development of the invention provides furthermore that the guide portion has been angled radially outwards away from the receiving opening. In this case, in accordance with the invention it may be stipulated that the angular magnitude by which the guide portion is angled away assumes a generally small value between 1° and 40°, particularly preferably between 5° and 20°. By angling the guide portion away, a centring action with respect to the restoring spring is generally obtained in the event of a relative motion of receiving opening and restoring spring, with a sufficiently reliable support in the radial direction being ensured at the same time. Consequently a durably concentric arrangement of a cylindrical restoring spring relative to the displacement axis can be obtained, for example.

In a further development of the invention it is stipulated that the stop portion has been angled radially inwards away from the receiving opening. In this case, in accordance with the invention it may be stipulated that the stop portion has been angled away from the receiving opening by an angular magnitude between 20° and 120°, particularly preferably by a magnitude from 40° to 80°. Generally, by virtue of such an angling of the stop portion an end face for supporting the restoring spring can be made available in particularly simple and compact manner, by virtue of which the restoring spring can be prevented from falling out of the receiving opening. By virtue of an angling by an angle of less than 90°, particularly preferably between 40° and 80°, it is ensured that a sufficiently large stop face has been made available without an insertion of the master-brake-cylinder device into the receiving opening being too greatly impaired.

In a further development of the invention it is stipulated that the stop portion at least partly overlaps radially with the second end of the restoring spring. By virtue of such a radial overlap, an axial displacement of the restoring spring can be avoided particularly effectively.

Similarly, in accordance with the invention it may be stipulated that the guide portion at least partly overlaps axially with the second end of the restoring spring. Such an axial overlap offers an effective point of support in the radial direction and similarly an axial guidance and consequently also centring of the restoring spring.

A further development of the invention provides that the receiving opening has been designed as a cross-sectional region of a tubular collar extending from the booster housing. In this case, the collar may generally have been designed as a receiving portion with guiding or supporting and centring action for the master-brake-cylinder arrangement and/or the restoring spring. It may preferentially be stipulated, furthermore, that the receiving opening has been designed as that cross-sectional region of the collar which is situated directly opposite the restoring spring—that is to say, typically, as an axial end of the collar situated opposite the restoring spring.

In this context it may furthermore be stipulated in accordance with the invention that the collar extends concentrically in relation to the displacement axis. Similarly, in accordance with the invention it may be stipulated that the collar extends at least partly into the booster housing. This simplifies the assembly of the master-brake-cylinder arrangement and the brake booster as a whole and ensures a reliable mode of operation of the brake booster in the case of a compact construction.

A further development of the invention provides that the guide portion and the stop portion directly support the second end of the restoring spring only prior to assembly of the brake booster with the master-brake-cylinder arrangement, and after the assembly the second end of the restoring spring has been lifted away from the guide portion and the stop portion. The supporting of the restoring spring can accordingly be taken over, so to speak, by the master-brake-cylinder arrangement after assembly. As a result, an optimal relative positioning of master-brake-cylinder arrangement, restoring spring and control valve is ensured without additional and possibly disrupting influences of the retaining device according to the invention. It will be understood that, in accordance with the invention, it may similarly be stipulated that in consequence of a disassembly or detachment of the master-brake-cylinder arrangement from the brake booster once again a supporting of the restoring spring is established by the retaining device according to the invention.

The invention further relates to a brake-boosting arrangement comprising a brake booster according to one of the variants described above and a master-brake-cylinder arrangement. In this case, in accordance with the invention it is stipulated that the master-brake-cylinder arrangement exhibits an axial end portion which extends into or through the receiving opening of the brake booster, the outer peripheral surface of the axial end portion having been profiled to correspond to the guide portion and/or to the stop portion. A corresponding profiling in this case is to be understood to mean, in particular, a profiling of a type that enables a collision-free insertion of the master-brake-cylinder arrangement into the receiving opening and past the retaining device.

In this context, in accordance with the invention it may furthermore be stipulated that the axial end portion exhibits in its outer peripheral surface a recess that has been designed to receive the guide portion of the receiving opening. In this case, for the purpose of simplifying the assembly it is particularly advantageous if the recess has been dimensioned to be larger in the peripheral direction than the guide portion, by virtue of which a certain tolerance with respect to the relative positioning of the components in relation to one another has been made available.

Furthermore, in this context it may be stipulated in accordance with the invention that the axial end portion has been designed as part of a separate attachment sleeve which has been fitted to the master-brake-cylinder arrangement. This makes it possible that no changes have to be made in respect of the master-brake-cylinder arrangement as such, but merely the separate attachment sleeve has to be adapted to the brake booster designed with the retaining device according to the invention. In this case, in accordance with the invention it may advantageously be stipulated that the attachment sleeve has been produced from a synthetic material. This enhances the freedom of styling and consequently the possibilities for designing a profile of the axial end portion to correspond to the guide portion and/or stop portion. The fitting of the attachment sleeve to the master-brake-cylinder arrangement may be effected, for example, by means of a screw joint.

The attachment sleeve may in addition have been designed with at least one end face via which the restoring spring is supported with its second end on the master-brake-cylinder arrangement. In this case, the second end of the restoring spring, in particular in the form of a terminal turn, may also have been received in recesses in the end face. The reception of the second end may be obtained particularly effectively by virtue of such recesses which have been shaped to be substantially complementary to the second end of the restoring spring. This enables a positioning and a holding of the restoring spring in a desired orientation, and avoids a slipping of the restoring spring, particularly in the radial direction. Similarly, it may be stipulated that the second end of the restoring spring has been received within the recesses in such a manner that a twisting of the restoring spring in at least one direction about the displacement axis has been blocked, for example by provision of appropriate stop faces within the recess.

The invention will be elucidated in exemplary manner in the following with reference to the appended Figures.

Represented are:

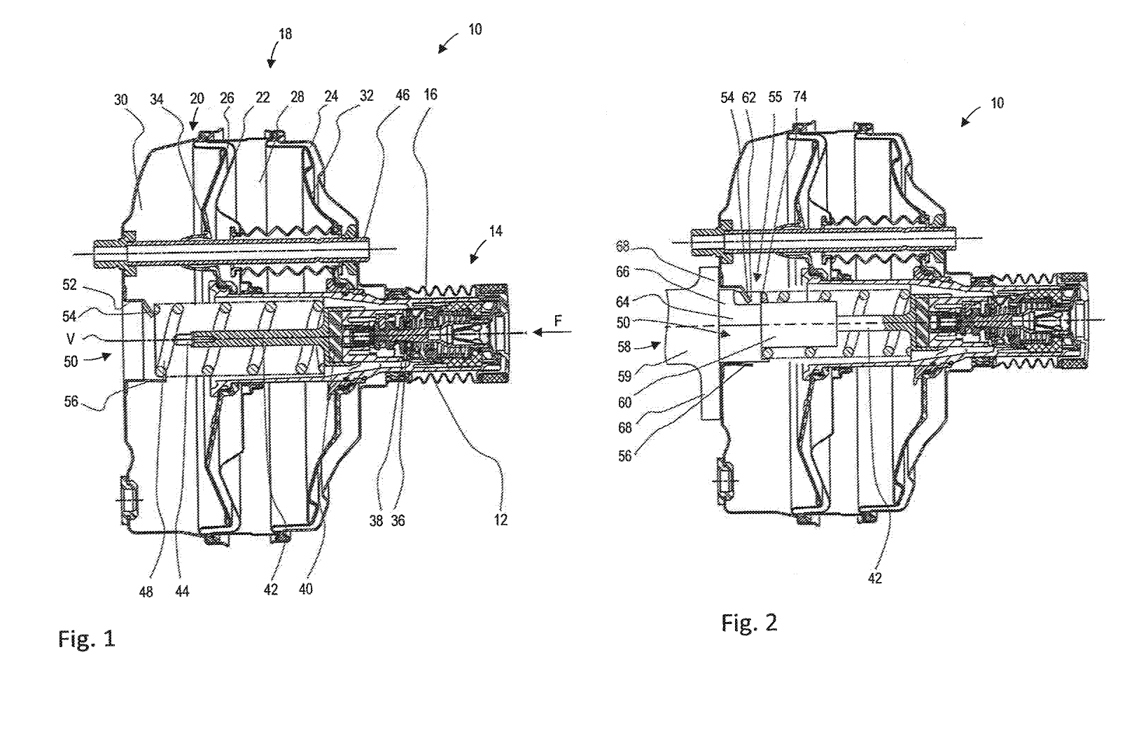

FIG. 1 an axis-including sectional view of a brake booster according to the invention according to one embodiment of the invention, with a guide portion and a stop portion each shown in cross section;

FIG. 2 the brake booster according to FIG. 1 with master-brake-cylinder arrangement inserted therein;

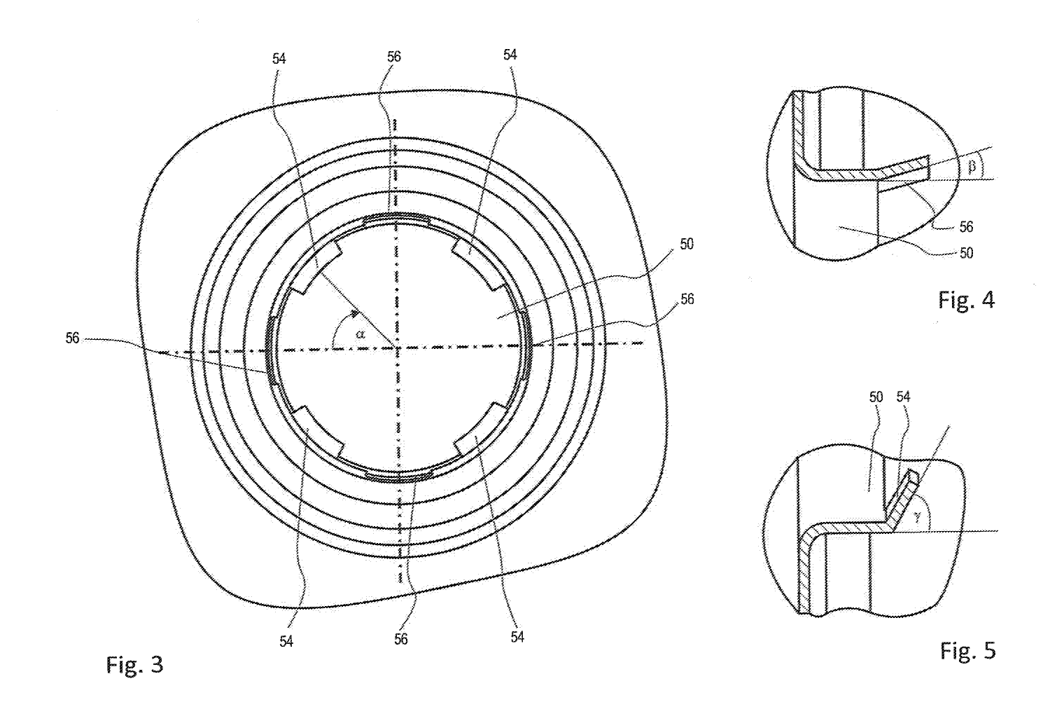

FIG. 3 a detailed view of the receiving opening of the brake booster according to FIG. 1;

FIG. 4 a detailed view of a guide portion according to FIG. 3;

FIG. 5 a detailed view of a stop portion according to FIG. 3;

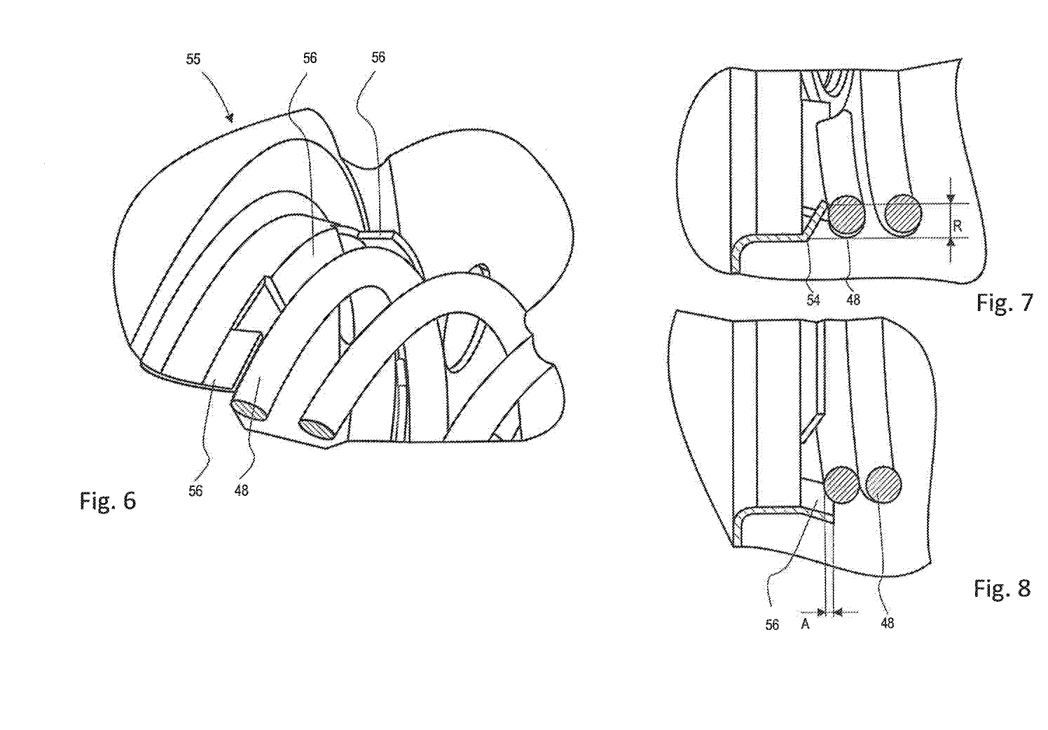

FIG. 6 a detailed view of the receiving opening from FIG. 3 with restoring spring arranged thereon;

FIG. 7 a detailed view of an abutment portion according to FIG. 6;

FIG. 8 a detailed view of a guide portion according to FIG. 6;

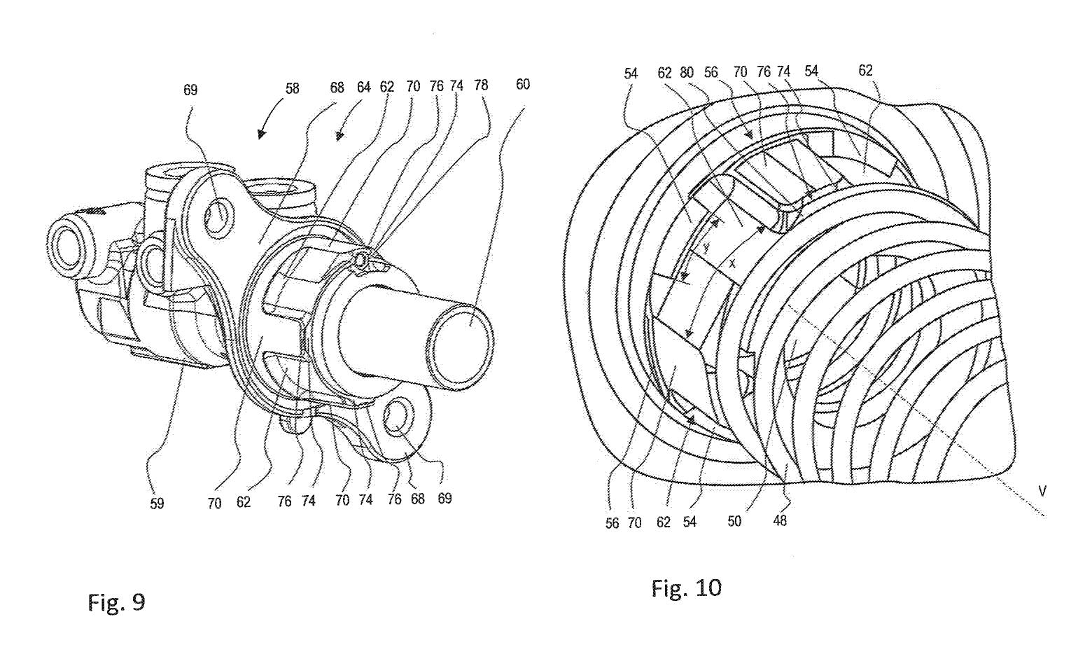

FIG. 9 a master-brake-cylinder arrangement with profiled attachment sleeve for assembly with a brake booster according to FIGS. 1 to 8; and

FIG. 10 a detailed view of the attachment sleeve from FIG. 9 inserted in the receiving opening according to FIG. 6.

In FIG. 1 a brake booster according to the invention is shown in an axis-including sectional view and is denoted generally by 10. The brake booster includes a force-input member 12 which can be acted upon via a brake pedal, which is not represented, with a force F and can be displaced to the left in FIG. 1 along a displacement axis V. Coupled with the force-input member 12 is an, in itself, conventionally constructed control valve 14, the casing 16 of which is displaceable relative to a booster housing 18. Located in the booster housing 18 is a tandem chamber arrangement 20 which has been subdivided into two parts via a wall 22 firmly installed in the booster housing 18. Each part comprises a working chamber 24 and 26, respectively, and a vacuum chamber 28, 30. Working chamber 24 has been separated from vacuum chamber 28 via a movable wall 32. Working chamber 26 has been separated from vacuum chamber 30 via a further movable wall 34.

Both movable walls 32, 34 have been firmly coupled with the control-valve casing 16 for the purpose of common motion. In the control valve 14 two valve seats 36, 38 have been arranged, the first valve seat 36 separating the working chambers 24 and 26 from the ambient atmosphere, and the second valve seat 38 separating the working chambers 24 and 26 from the vacuum chambers 28 and 30.

The control-valve casing 16 has been coupled with a force-output member 42 via a resilient reaction member 40. The force-output member 42 exhibits at its left end in FIG. 1 a peg-like projection 44 with which it can be coupled in force-transmitting manner with a downstream master-brake-cylinder arrangement 58 which is not represented in FIG. 1. The booster housing 18 is penetrated by tension bolts 46 via which the brake booster 10 can be fitted to a splash wall.

In FIG. 1 a restoring spring 48 can further be discerned which is supported at one end on the control-valve casing 16.

As already explained, the brake booster 10 is shown in FIG. 1 in a preassembly position—that is to say, in a position in which the brake booster 10 has not yet been coupled with a master-brake-cylinder arrangement 58. In this state, the restoring spring 48 is supported on the booster housing 18 in the region of a receiving opening 50. The receiving opening 50 has generally been provided for receiving the master-brake-cylinder arrangement 58 which is not represented in FIG. 1, and has been designed as a cross-sectional region of a collar 52 extending concentrically in relation to the displacement axis V and into the booster housing 18. In this connection, the receiving opening 50 has been designed with a retaining device 55 in the form of a stop portion 54 angled radially inwards and a guide portion 56 extending axially into the booster housing and angled slightly radially outwards. The stop portion 54 and the guide portion 56 have been integrally formed, respectively, onto the receiving opening 50 and onto the collar 52 merging integrally with the booster housing. Furthermore, the stop portion 54 and the guide portion 56 and also the collar 52 have been produced from the same material as the booster housing 18.

In FIG. 1 only one stop portion 54 and the guide portion 56 in an opposing configuration have been represented, this serving, however, merely for explanatory purposes. The precise arrangement and number of guide portions 56 and stop portions 54 on the receiving opening 50 will be elucidated in still more detail with reference to the following Figures.

In FIG. 1 it will be discerned that the stop portion 54 overlaps radially with the restoring spring 48. Consequently the stop portion 54 makes available a stop limiting the axial motion of the restoring spring 48, by virtue of which the restoring spring 48 is prevented from falling out of the receiving opening 50 which has been provided with a larger diameter. It will further be discerned in FIG. 1 that the guide portion 56 overlaps axially with the restoring spring 48. This limits a motion of the restoring spring 48 in the radial direction. Furthermore, the restoring spring 48 can as a result be oriented in a desired position relative to the displacement axis V.

The brake booster according to FIG. 1 operates in a manner known as such. That is to say, in the event of an actuation of the brake pedal, which is not shown, a force F is exerted on the force-input member 12, so that the force-input member 12 is displaced to the left in FIG. 1 in the axial direction V. As a result, the first seating 36 is opened, so that a build-up occurs of a differential pressure on the movable walls 32 and 34. The latter cause the booster housing 18 to be displaced to the left in FIG. 1 until the first seating 36 closes again. Consequently the actuating force F is transmitted in boosted manner to the following braking system via the force-output member 42 by the booster action resulting from the differential pressure on the movable walls 32 and 34. Upon release of the brake pedal, the processes described above proceed in reverse order, so that a relief of pressure occurs on the movable walls 32 and 34 until the brake booster 10 again returns to its initial position shown in FIG. 1.

In FIG. 2 the brake booster 10 is shown in a state assembled with a master-brake-cylinder arrangement 58. The force-output member 42 in this case has been coupled with a displaceable actuating piston 60 of the master-brake-cylinder arrangement 58, protruding from a generally fixed master-brake-cylinder housing 59.

Consequently the force-output member 42 can transmit a braking force to the actuating piston 60, so that the latter is displaced within the brake-cylinder housing 59. As a result, braking forces can be built up in generally known manner within a brake system downstream of the brake booster 10.

In FIG. 2 it will further be discerned that the second end of the restoring spring 48 is supported on an end face 74 of the master-brake-cylinder arrangement 58, as a result of which the control valve 14 has been biased into the initial position thereof. Consequently the restoring spring 48 is no longer supported, as in the preassembled state, on the retaining device 55 formed on the receiving opening 50, but has been lifted away therefrom. The second end of the restoring spring 48 has been displaced further into the booster housing 18, corresponding to FIG. 2.

In the course of assembly of the master-brake-cylinder arrangement 58 with the brake booster 10, an axial end portion 64 of the master-brake-cylinder housing 59 has to be inserted into the receiving opening 50 and also pushed a certain amount through the receiving opening 50. In order in this process to avoid collisions with the guide portion 56 projecting radially inwards, the axial end portion 64 has been designed as an attachment sleeve 66, described in still more detail below and represented only schematically in this Figure, in the outer peripheral surface of which several recesses 62 have been formed. The recesses 62 have been dimensioned in such a manner that they can receive at least one guide portion 56, so that the master-brake-cylinder housing 59 with its axial end portion 64 can be moved axially through the receiving opening 50 without collision. The attachment sleeve 66 exhibits, in addition, the end face 74 via which the second end of the restoring spring 48 is supported on the master-brake-cylinder arrangement. As is evident furthermore from FIG. 2, the depth of insertion of the master-brake-cylinder housing 59 is limited by stop flanges 68 as soon as the latter come into abutment with an outside of the booster housing 18.

FIG. 3 shows a detailed view of the retaining device 55 according to the Figures described above. It will be discerned firstly that the receiving opening 50 has been designed with a plurality of stop portions 54 and guide portions 56, four stop portions 54 and four guide portions 56 having been provided in the case shown. The portions have been uniformly distributed in the peripheral direction along the receiving opening 50, so that they have been offset in relation to one another in the peripheral direction substantially by an angle α of 45°.

In FIGS. 4 and 5, sectional views of a guide portion 56 and of a stop portion 54 from FIG. 3 are shown, respectively. In FIG. 4 the upper guide portion 56 in FIG. 3—to be more exact, the one arranged at an angle α of 90°—is shown. It will be discerned that the guide portion 56 has been angled slightly radially outwards by an angle β with respect to the receiving opening 50. In the case shown, angle β amounts to 20°.

In FIG. 5 one of the stop portions 54 from FIG. 3 is shown, said portion being angled radially inwards by an angle γ with respect to the receiving opening 50. In the case shown, angle γ amounts to 60°.

In FIGS. 6 to 8 the retaining device 55 according to the preceding Figures is shown in a detailed view and in engagement with the restoring spring 48. Here, particularly in FIGS. 7 and 8, the radial overlap R of the stop portions 54 with the restoring spring 48 and also the axial overlap A of the guide portions 56 with the restoring spring 48 will be discerned once again. Furthermore, it becomes evident that the forming of the guide portions 56 so as to be angled radially outwards also provides a centring action, by reason of which the restoring spring 48 can be brought into a desired set position relative to the displacement axis V, which is not shown in these Figures, and by virtue of which a general tolerance compensation between the components is made possible.

In FIG. 9 the master-brake-cylinder arrangement 58 described in connection with FIG. 2 is shown in a representation of its component parts. Once again, the stop flanges 68 and also the actuating piston 60 and the attachment sleeve 66 forming the axial end portion 64 of the master-brake-cylinder housing 59 will be discerned. From FIG. 9 the profiled design of the outer peripheral surface of the attachment sleeve 66 is again clarified, which has been designed with several recesses 62 for receiving a respective guide portion 56. In this connection, the attachment sleeve in the case shown has been produced from a synthetic material, by virtue of which great freedom of styling is guaranteed. The stop flanges 68 further exhibit bores 69 for receiving fastening means, in order to fasten the master-brake-cylinder arrangement 58 to the brake booster 10.

It will further be discerned in FIG. 9 that the regions of the outer peripheral surface of the attachment sleeve 66 adjoining the recesses 62 have been designed as rib-shaped portions 70. The latter exhibit recesses 76 on their outer axial ends or end faces 74 for supporting and receiving the second end of the restoring spring 48. The recesses 76 in this case have been shaped to be complementary to the second end of the restoring spring, extending, in the case shown, into the end faces 74 on a radially outer edge of the end faces 74 substantially in the peripheral direction and with a concave vaulting. On the end face 74 of the upper rib-shaped portion 70 in FIG. 9 a screw 78 can further be discerned with which the attachment sleeve 66 has been fastened to the master-brake-cylinder housing 59.

In FIG. 10 the attachment sleeve 66 is shown in a state inserted within the receiving opening 50. For reasons of clarity, the further components of the master-brake-cylinder arrangement 58 have not been represented separately in this case. It will be discerned that, in each instance, a stop portion 54 has been received in one of the recesses 62 of the attachment sleeve, the extent x of the recesses 62 in the peripheral direction clearly exceeding the extent y of the stop portions 54 in the peripheral direction.

It will further be discerned in FIG. 10 that the restoring spring 48 is supported with its second end, which in the case shown is formed by the outer end of a terminal turn 80, on the upper rib 70 in FIG. 10 and has been received in the recess 76 arranged there. As a result, the second end of the restoring spring 48 is held by the attachment sleeve 66 in a defined orientation and position on the master-brake-cylinder arrangement 58.

1. Brake booster (10) for a motor-vehicle brake system, with
a force-input member (12) which is coupled or can be coupled with a brake pedal and which is displaceable along a displacement axis (V),
a control valve (14) which can be actuated in accordance with a displacement of the force-input member (12),
a chamber arrangement (20) which is arranged in a booster housing (18) and can be selected via the control valve (14), with at least one vacuum chamber (28, 30) and with at least one working chamber (24, 26), which have been separated from one another via at least one movable wall (32, 34) coupled with the control valve (14), and
a force-output member (42) for delivering a braking force to a downstream master-brake-cylinder arrangement, wherein the control valve (14) with the force-output member (42) has been biased into an initial position with the aid of a restoring spring (48), wherein the restoring spring (48) is supported with a first end on the control valve (14),
characterised in that the booster housing (18) exhibits a receiving opening (50) for the downstream master-brake-cylinder arrangement (58), which has been designed with at least one axial guide portion (56) and with at least one radial stop portion (54), which have each been configured to support a second end of the restoring spring (48).

2. Brake booster (10) according to claim 1,
characterised in that the guide portion (56) and the stop portion (54) extend at least partly in a common peripheral-segment region of the receiving opening (50) and have been arranged to be axially adjacent.

3. Brake booster (10) according to claim 1,
characterised in that the guide portion (56) and the stop portion (54) extend substantially in different peripheral-segment regions of the receiving opening (50).

4. Brake booster (10) according to claim 3,
characterised in that the receiving opening (50) has been designed with a plurality of guide portions (56) and/or stop portions (54) and the guide portions (56) and stop portions (54) have been arranged to be substantially uniformly distributed along the periphery of the receiving opening (50).

5. Brake booster (10) according to one of the preceding claims,
characterised in that the guide portion (56) has been angled radially outwards away from the receiving opening (50).

6. Brake booster (10) according to one of the preceding claims,
characterised in that the stop portion (54) has been angled radially inwards away from the receiving opening (50).

7. Brake booster (10) according to one of the preceding claims,
characterised in that the stop portion (54) at least partly overlaps radially with the second end of the restoring spring (48).

8. Brake booster (10) according to one of the preceding claims,
characterised in that the guide portion (56) at least partly overlaps axially with the second end of the restoring spring (48).

9. Brake booster (10) according to one of the preceding claims,
characterised in that the receiving opening (50) has been designed as a cross-sectional region of a tubular collar (52) extending from the booster housing (18).

10. Brake booster (10) according to claim 9,
characterised in that the collar (52) extends concentrically in relation to the displacement axis (V).

11. Brake booster (10) according to claim 9 or 10,
characterised in that the collar (52) extends at least partly into the booster housing (18).

12. Brake booster (10) according to one of the preceding claims,
characterised in that the guide portion (56) and the stop portion (54) directly support the second end of the restoring spring (48) only prior to assembly of the brake booster (10) with the master-brake-cylinder arrangement (58), and after assembly the second end of the restoring spring (48) has been lifted away from the guide portion (56) and the stop portion (54).

13. Brake-boosting arrangement,
comprising a brake booster (10) according to one of the preceding claims and a master-brake-cylinder arrangement (58),
characterised in that the master-brake-cylinder arrangement (58) exhibits an axial end portion (64) which extends into or through the receiving opening (50) of the brake booster (10), wherein the outer peripheral surface of the axial end portion (50) has been profiled to correspond to the guide portion (56) and/or to the stop portion (54).

14. Brake-boosting arrangement according to claim 13,
characterised in that the axial end portion (64) exhibits a recess (62) in its outer peripheral surface, which has been designed to receive the guide portion (56) of the receiving opening (50).

15. Brake-boosting arrangement according to claim 14,
characterised in that the axial end portion (64) has been designed as part of a separate attachment sleeve (66) which has been fitted to the master-brake-cylinder arrangement (58).
